(19) United States
(12) Patent Application Publication
(10) Pub. No.: US 2006/0197653 A1
(43) Pub. Date: Sep. 7, 2006

(54) Radio frequency identification monitoring system and method

(75) Inventors: Shao-Tsu Kung, Taipei (TW); Yi-Hung Shen, Taipei (TW)

Correspondence Address: PAUL S MADAN;MADAN, MOSSMAN & SRIRAM, PC, 2603 AUGUSTA, SUITE 700, HOUSTON, TX, 77057-1130, US

(73) Assignee: COMPAL ELECTRONICS, INC., Taipei (TW)

(21) Appl. No.: 11/226,229

(22) Filed: Sep. 15, 2005

(30) Foreign Application Priority Data
Mar. 7, 2005 (TW) 94106851

(51) Int. Cl. H04Q 5/22

(52) U.S. Cl. 340/10.34

(57) ABSTRACT

Several readers are disposed in different positions within a region for receiving a tag ID code of a radio frequency identification (RFID) tag. The RFID tag has a power supply and a lock circuit, and the lock circuit switches the power supply. When one of the readers receives the tag ID code, the tag ID code is compared to an assigned ID code. If the tag ID code is the same as the assigned ID code, the power supply is enabled to provide electrical power for repeatedly sending the tag ID code. Then, the position of the RFID tag is identified by the readers which receive the tag ID code.

### RELATED APPLICATIONS

The present application is based on, and claims priority from, Taiwan Application Serial Number 94106851, filed Mar. 7, 2005, the disclosure of which is hereby incorporated by reference herein in its entirety.

### BACKGROUND

1. Field of Invention

The present invention relates to a radio frequency identification (RFID) system. More particularly, the present invention relates to an RFID monitoring system and method which can control the electrical power supplying of an RFID tag.

2. Description of Related Art

Radio frequency identification (RFID) is a non-contact automatic identification technique, which automatically identifies targets and obtains relative information by radio frequency signals, so as to have a fast and convenient process, omit manual operations during identifying and be able to identify plural tags and even dynamic targets simultaneously.

A complete RFID system comprises two parts, a reader and a transponder. The transponder is generally called an RFID tag. The operational principle of the RFID system is to transmit radio frequency energy of a certain frequency to the transponder for driving it to transmit its tag ID code, or alternatively, to transmit the tag ID code by the transponder itself. The reader receives the tag ID code and transmits it to a central system for carrying out relative data processes.

Because the electrical power for the RFID tag to transmit the tag ID code is converted from radio frequency energy transmitted by the reader, the RFID tag is called a passive RFID tag. The signal transmission range of the passive RFID tag is too short, and the signal intensity of the same is weak. Alternatively, a power supply can be configured in the RFID tag for continuously supplying electrical power to transmit the tag ID code. This RFID tag, which has a built-in power supply, is called an active RFID tag. The active RFID tag continuously transmits the tag ID code while it approaches the reader, and therefore it overly consumes electrical power such that its attached power supply can not support a long lifespan.

Modern RFID applications include logistics and supply management, manufacture and assemblage, airport baggage service, mail and express delivery, file tracking and library management, animal identification, access control, electrical entrance tickets and automatic fare collection. However, the so-called access control is only to obtain and identify the tag ID code of the RFID tag along with the user by the reader, without the function of tracking or recording the route of the user moving within a certain region.

### SUMMARY

It is therefore a first objective of the present invention to provide a radio frequency identification (RFID) monitoring method, which can turn on or cut off the electrical power supplying of the RFID tag according to requirements and conditions, facilitating the searching, recording, and tracking the position of the RFID tag within a region.

According to a first embodiment of the present invention, a tag ID code of an RFID tag is received by at least one reader disposed within a region. The RFID tag has a control circuit, an antenna, a power supply and a lock circuit. The control circuit is electrically connected to the antenna and the power supply and is used to store the tag ID code. The lock circuit switches the power supply. When the reader receives the tag ID code, the tag ID code is compared to an assigned ID code. When the tag ID code is the same as the assigned ID code, the power supply is enabled to provide electrical power for repeatedly sending the tag ID code. Then, the position of the RFID tag is identified by the reader which receives the tag ID code.

It is a second objective of the present invention to provide a radio frequency identification (RFID) monitoring system, which can enhance monitoring capacity and accuracy by readers configured on different positions and a RFID tag having controllable electrical power supplying.

According to the first embodiment of the present invention, the RFID monitoring system comprises an RFID tag, a plurality of readers and a central controller. The RFID tag has a tag ID code and comprises a control circuit, an antenna, a power supply and a lock circuit. The control circuit is electrically connected to the antenna and the power supply and is used to store the tag ID code. The power supply is enabled or disabled by the lock circuit. The readers are disposed on different positions within a region, for receiving the tag ID code and determining whether the tag ID code is the same as an assigned ID code. When the tag ID code is the same as the assigned code, one of the readers transmits an enable signal to enable the power supply of the RFID tag. The readers report their positions to the central controller, and the central controller identifies a route of the RFID tag moving within the region according to the positions of the readers.

It is a third objective of the present invention to provide an RFID tag, whose power supply can be enabled or disabled according requirements and conditions, saving electrical power to extend its lifespan and enhancing its mobility.

According to a second preferred embodiment of the present invention, the RFID tag comprises a control circuit, an antenna, a power supply and a lock circuit. The antenna is used to receive an enable signal or a disable signal. The control circuit is electrically connected to the antenna. The power supply supplies electrical power for the control circuit to transmit a tag ID code through the antenna. The lock circuit is electrically connected to the power supply and enables and disables the power supply according to the enable signal and the disable signal, respectively.

It is a fourth objective of the present invention to provide an RFID monitoring method. A tag ID code of an RFID tag is received by at least one reader disposed within a region. The RFID tag has a control circuit, an antenna, a power supply and a lock circuit. The control circuit is electrically connected to the antenna and the power supply and is used to store the tag ID code. The lock circuit switches the power supply. When the RFID enters the region, an enable signal is transmitted by one of the readers to enable the power supply to provide electrical power. When one of the readers receives the tag ID code, the reader determines whether the tag ID code is the same as an assigned code provided by a central controller. When the tag ID code is the same as the assigned code, the reader reports its position to the central controller, and the central controller identifies a route of the RFID tag moving within the region according to the positions of the readers.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A is a schematic view of an RFID tag in a first preferred embodiment of the present invention;

FIG. 1B is a schematic view of an RFID monitoring system in the preferred embodiment of the present invention;

FIG. 2 is a flow chart of the first preferred embodiment of the present invention;

FIG. 3 is a flow chart of a second preferred embodiment of the present invention; and

FIG. 4 is another flow chart of the second preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention adds a lock circuit into an active RFID tag for controlling the switching of a power supply of the active RFID tag. By cooperating with an enable signal or a disable signal transmitted from a central controller through a reader, the monitoring capacity of the RFID system within a certain region is enhanced, and the power consumption of the active RFID tag is decreased, thus extending its battery life.

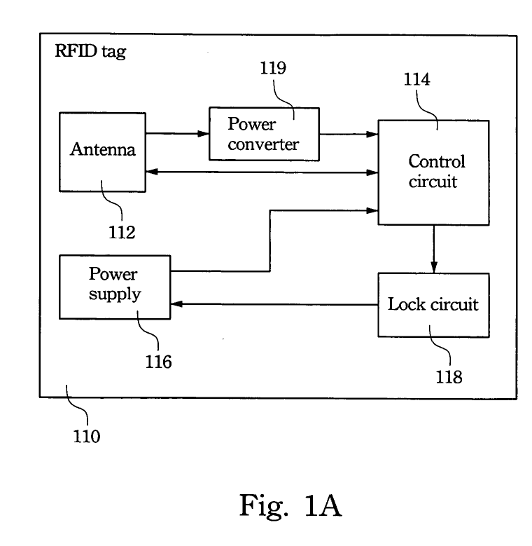

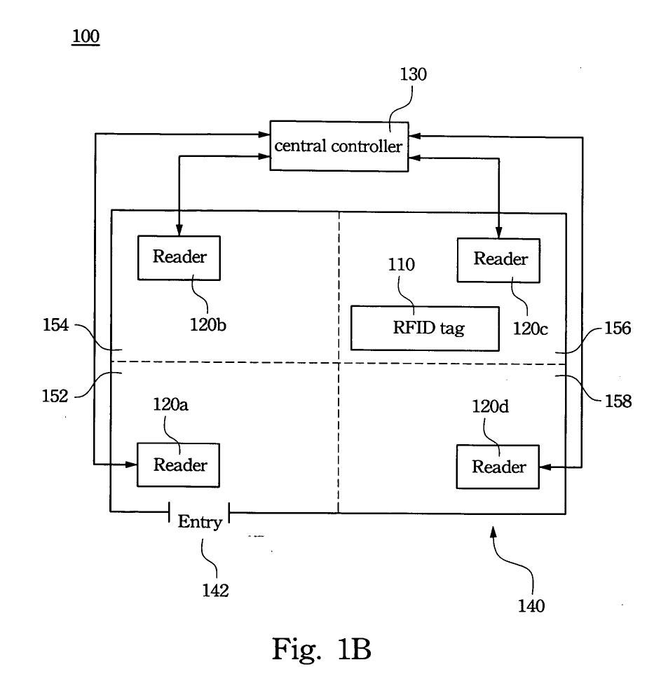

FIG. 1A is a schematic view of an RFID tag in a first preferred embodiment of the present invention. As illustrated in FIG. 1A, an RFID tag 110 comprises an antenna 112, a control circuit 114, a power supply 116 and a lock circuit 118. The antenna 112 is used to receive an enable signal or a disable signal. The control circuit 114 is electrically connected to the antenna 112 and stores a tag ID code. The power supply 116 supplies electrical power for the control circuit 114 to transmit the tag ID code through the antenna 112. The lock circuit 118 is electrically connected to the power supply 116 and enables and disables the power supply 116 according to the enable signal and the disable signal, respectively.

In the first preferred embodiment, after receiving the enable signal or the disable signal transmitted from the antenna 112, the control circuit 114 notifies the lock circuit 118 to enable or disable the power supply 116. Alternatively, the antenna can directly transmit the enable signal or the disable signal to the lock circuit 108. In addition, the control circuit 114 and the lock circuit 118 can be simultaneously integrated into a single controller.

Moreover, the RFID tag 110 further comprises a power converter 119. The power converter 119 converts a signal that is received by the antenna 112 into an electrical power for the control circuit 114 to transmit the tag ID code through the antenna 112. In other words, the RFID tag concurrently has the functions of the active RFID tag and the passive RFID tag. Furthermore, after the power supply 116 is enabled for a predetermined period, the lock circuit 118 automatically cuts off the power supplying of the power supply 116, thus improving the power saving of the RFID tag 110.

FIG. 1B is a schematic view of an RFID monitoring system in the preferred embodiment of the present invention. The following descriptions are made with references to FIG. 1A and FIG. 1B. As illustrated in FIG. 1A, the RFID monitoring system 100 comprises the RFID tag 110, a plurality of readers 120a, 120b, 120c and 120d, and a central controller 130. The readers 120a, 120b, 120c and 120d are disposed on different positions within a region 140 for receiving the tag ID code of the RFID tag 110 and determining whether the tag ID code is the same as an assigned ID code.

When the tag ID code is the same as the assigned code, one of the readers 120a, 120b, 120c and 120d, such as the one which is closest to the RFID tag 110, transmits an enable signal to enable the power supply 116 of the RFID tag 110. The central controller 130, such as a server or other suitable controller, identifies the position of the RFID tag 110 within the region 140 by receiving the tag ID code through the readers 120a, 120b, 120c and 120d.

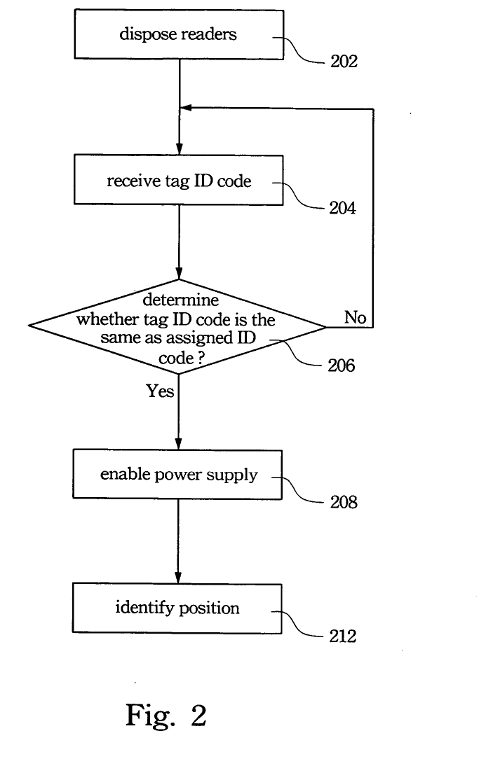

FIG. 2 is a flow chart of the first preferred embodiment of the present invention, illustrating the RFID monitoring method of the present invention. For clarity, the following descriptions are made with references to FIG. 1A, FIG. 1B and FIG. 2.

The preferred embodiment firstly configures the readers 120a, 120b, 120c and 120d on different positions within the region 140 for receiving the tag ID code of the RFID tag 110 (step 202). When one of the readers 120a, 120b, 120c and 120d receives the tag ID code (step 204), the tag ID code is compared to an assigned ID code, determining whether the tag ID code is the same as the assigned ID code (step 206). When the tag ID code is the same as the assigned ID code, the power supply 116 is enabled to provide electrical power for repeatedly sending the tag ID code (step 208). Then, the position of the RFID tag 110 within the region 140 is identified by receiving the tag ID code through the readers 120a, 120b, 120c and 120d (step 212).

Generally, the reader has a preferred available region due to the distance limitation of radio frequency transmission. As illustrated in FIG. 1B, each of the readers 120a, 120b, 120c and 120d are separately in charge of receiving radio frequency signals within each subregions 152, 154, 156 and 158, respectively. The central controller 130 can identify which subregions 152, 154, 156 and 158 the RFID tag 110 is positioned in by these corresponding readers 120a, 120b, 120c and 120d that are in charge of different subregions.

For example, when a plurality of RFID tags 110 exist in the region 140, a wanted RFID tag 110 can be firstly assigned. When the wanted RFID tag 110 approaches one of the readers 120a, 120b, 120c and 120d, the power supply 116 of the RFID tag 110 is enabled to make the RFID tag 110 continuously transmit its tag ID code. Moreover, because the power supply 116 generally supplies a greater amount of electrical power than that induced by the power converter 119, the tag ID code therefore can be transmitted to a farther distance by electrical power provided from the power supply 116, thus increasing the possibility of successfully detecting the tag ID code by the readers 120a, 120b, 120c and 120d.

The RFID tag can be disposed on a movable object, such as a user, a portable electronic device, a book, or other object that may be taken by a user and moved along with the user. Therefore, with continuously detecting the tag ID code by the readers 120a, 120b, 120c and 120d that are separately in charge of different subregions 152, 154, 156 and 158, a real-time position of the wanted RFID tag 110 within the region 140 can be instantly identified.

Moreover, the different spatial positions of the readers and the different transmission ranges of the RFID tag can be further used to estimate a more precise position of the RFID tag 110. As mentioned above, the transmission range of the tag ID code can be adjusted by the different amounts of electrical power supplied for transmitting the tag ID code. For example, the transmission region of the tag ID code can be adjusted by different amounts of electrical power from the power supply 116 and the power converter 119, or by different amounts of electrical power supplied from the power supply 116 due to different enable signals.

According to the second preferred embodiment of the present invention, the readers 120a, 120b, 120c and 120d can be suitably disposed spatially within the region 140. The central controller 130 uses the spatial distribution of the readers 120a, 120b, 120c and 120d and the different amounts of power supplying to estimate a more precise position of the RFID tag 110 within the region 140 according to the corresponding variations of which readers can receive the tag ID code under the different amounts of power supplying.

In another aspect, the coverage of each of the subregions 152, 154, 156 and 158 is respectively determined by the signal transmission capacity of each of the readers 120a, 120b, 120c and 120d. Therefore, the coverage of each subregion 152, 154, 156 or 158 can be substantially enlarged by properly adjusting the power and the radio frequency of the corresponding reader. In addition to distributing the readers in a region with an arrangement, such as in a cellular distribution, the RFID monitoring system 100 can be used to monitor the RFID tags within an extensive region, such as within a town or a science park having many factories, rather than only within a restricted area or a single factory.

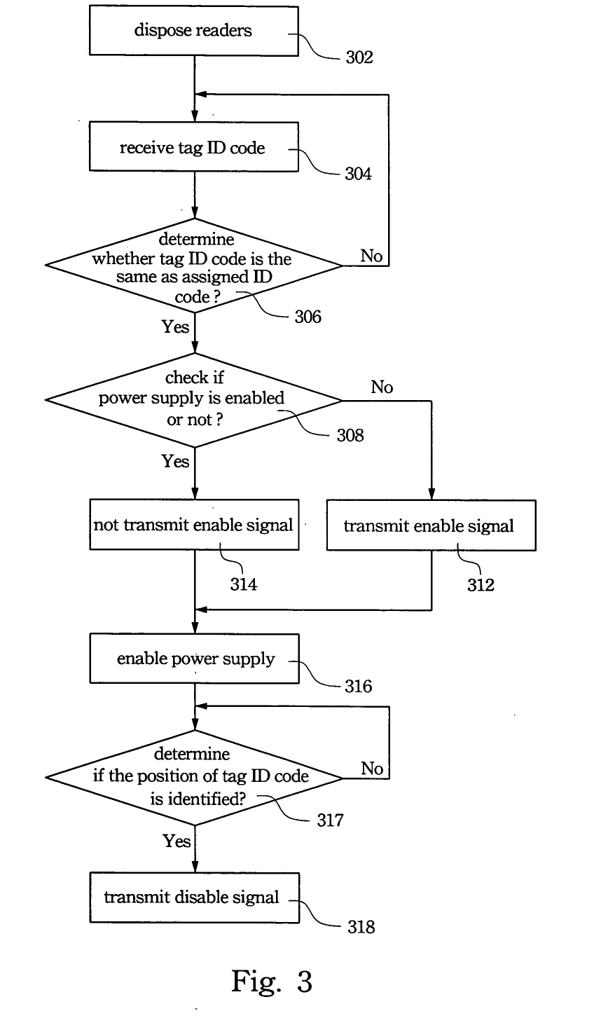

FIG. 3 is a flow chart of a second preferred embodiment of the present invention. Compared to the preferred embodiment as illustrated in FIG. 2, the preferred embodiment has additional steps of disabling the power supply after the position of the RFID tag is identified and determining whether or not the power supply is enabled. The preferred embodiment can increase the power efficiency of the active RFID tag, extending its battery life.

For clarity, the following descriptions are made with references to FIG. 1A, FIG. 1B and FIG. 3. The preferred embodiment firstly configures the readers 120a, 120b, 120c and 120d on different positions within the region 140 for receiving the tag ID code of the RFID tag 110 (step 302). When one of the readers 120a, 120b, 120c and 120d receives the tag ID code (step 304), the tag ID code is compared to an assigned ID code, determining whether the tag ID code is the same as the assigned ID code (step 306). When the tag ID code is the same as the assigned ID code, the power supply 116 is checked to determine whether it is enabled or not (step 308).

When the power supply 116 is not enabled, an enable signal is transmitted to the RFID tag 110, making the lock circuit 118 enable the power supply 116 to provide electrical power (step 312). When the power supply 116 is enabled, the enable signal is not transmitted (step 314). The position of the RFID tag 110 within the region 140 is identified by receiving the tag ID code through the readers 120a, 120b, 120c and 120d (step 316). Whether the position of the tag ID code (i.e. the RFID tag 110) within the region 140 is identified or not is then determined (step 317). When the position of the RFID tag 110 within the region 140 is identified, a disable signal is transmitted to the RFID tag 110 to make the lock circuit 118 disable the power supply 116 from providing electrical power, saving the power consumption of the power supply 116 (step 318).

The determining step 317 can be based on time; for example, the position of the identified RFID tag 110 can be directly decided after transmitting the enable signal for a few minutes, or after the RFID tag 110 has remained on or around a certain position for a period. Alternatively, this determining step 317 can use other criteria, such as an indication from the system administrator or from the user to whom the RFID tag belongs. The preferred embodiment does not limit the determining manner, and any other manners suitable for different situations should be included in the scope of the present invention.

More precisely, when an object on which the RFID tag 110 is configured has stopped moving or stayed in one of the subregions 152, 154, 156 and 158 for a period, or the object configuring the RFID tag 110 has passed by or entered into one of the subregions 152, 154, 156 and 158, or the system administrator believes the monitoring is completed, the enable can be transmitted to disable the power supply 116 from unnecessary power consumption.

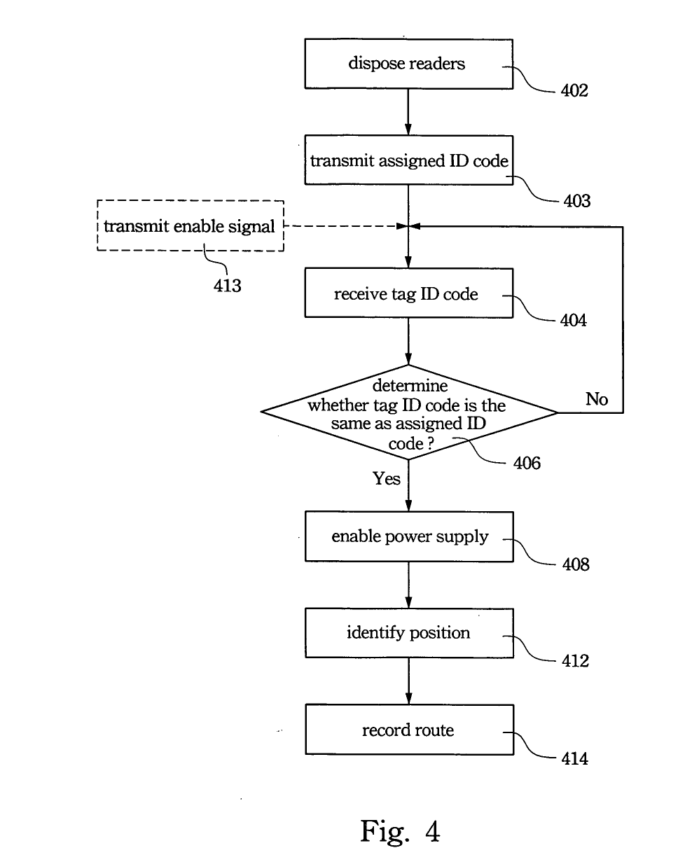

FIG. 4 is another flow chart of the second preferred embodiment of the present invention. Compared to the preferred embodiment as illustrated in FIG. 2, the preferred embodiment has additional steps of setting the assigned ID code and recording the route of the RFID tag moving within the region. Furthermore, the preferred embodiment can transmit the enable signal to enable the power supply when the RFID tag initially enters the region. Therefore, the second preferred embodiment further illustrates different applications of the RFID monitoring method and system of the present invention.

For clarity, the following descriptions are made with references to FIG. 1A, FIG. 1B and FIG. 4. The second preferred embodiment firstly configures the readers 120a, 120b, 120c and 120d on different positions within the region 140 for receiving the tag ID code of the RFID tag 110 (step 402). Moreover, the central controller 130 sets the assigned ID code and transmits the assigned ID code to the readers 120a, 120b, 120c and 120d (step 403).

The system administrator preferably sets or changes the assigned ID code by the central controller 130, thus enhancing the management flexibility of the RFID monitoring system. However, persons skilled in the art should understand that other manners for setting the assigned ID code, such as separately inputting into each reader or recording in the readers in advance, also fall within the scope of the present invention.

When one of the readers 120a, 120b, 120c and 120d receives the tag ID code (step 404), the tag ID code is compared to an assigned ID code, determining whether the tag ID code is the same as the assigned ID code (step 406). When the tag ID code is the same as the assigned ID code, the power supply 116 is enabled to provide electrical power for repeatedly sending the tag ID code (step 408). Then, the position of the RFID tag 110 within the region 140 is identified by receiving the tag ID code through the readers 120a, 120b, 120c and 120d (step 412). Moreover, the central controller 130 can identify the route of the RFID tag 110 moving within the region 140 by continuously receiving the tag ID code through the readers 120a, 120b, 120c and 120d (step 414).

In addition, in order to achieve the objectives of automatic recording, tracking or controlling, the enable signal can be transmitted to enable the power supply 116 for providing electrical power when the RFID tag 110 initially enters the region 140 (step 413). For example, the reader 120a, which is closest to an entry 142 of the region 140, is used to be an initial reader, which instantly transmits the enable signal to enable the power supply 116 when any RFID tag 110 enters the region 140 through the entry 142. The central controller 130 is ensured to fully record and track the position or route of every RFID tag 110 within the region 140.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A radio frequency identification (RFID) monitoring method, comprising the steps of:
a. receiving a tag ID code of an RFID tag by a reader disposed in a region, wherein the RFID tag comprising a control circuit is electrically connected to an antenna and a power supply, the control circuit is arranged to store the tag ID code, and the power supply is enabled or disabled by a lock circuit;
b. determining whether the tag ID code is the same as an assigned code when the reader receives the tag ID code;
c. when the tag ID code is the same as the assigned code, the reader transmitting an enable signal to the RFID tag to make the lock circuit enable the power supply to provide electrical power to the antenna for repeatedly transmitting the tag ID code; and
d. receiving the tag ID code by the reader to identify a position of the RFID tag within the region.

2. The RFID monitoring method as claimed in claim 1, wherein when the tag ID code is the same as the assigned code in the step c, the RFID monitoring method further comprises:
c1. determining whether or not the power supply is enabled;
c11. transmitting the enable signal to the RFID tag by the reader to make the lock circuit enable the power supply to provide electrical power when the power supply is not enabled; and
c12. not transmitting the enable signal when the power supply is enabled.

3. The RFID monitoring method as claimed in claim 1, wherein a setting of the assigned ID code further comprises the steps of:
a1. setting the assigned ID code by a central controller;
a2. transmitting the assigned ID code from the central controller to the reader; and
a3. receiving and storing the assigned ID code by the reader.

4. The RFID monitoring method as claimed in claim 1, wherein the step d further comprises:
when the reader receives the tag ID code, the reader reporting its position to a central controller to identify the position of the RFID tag within the region.

5. The RFID monitoring method as claimed in claim 1, after the step d further comprising a step of:
e. transmitting a disable signal to the RFID tag to make the lock circuit disable the power supply from providing electrical power.

6. A radio frequency identification (RFID) monitoring system, comprising:
an RFID tag having a tag ID code, wherein the RFID tag comprises:
a control circuit arranged to store the tag ID code;
an antenna electrically connected to the control circuit, wherein the antenna is arranged to transmit the tag ID code;
a power supply electrically connected to the control circuit; and
a lock circuit arranged to enable or disable the power supply;
a reader disposed within a region, the reader arranged to receive the tag ID code and determine whether the tag ID code is the same as an assigned ID code, wherein when the tag ID code is the same as the assigned code, and the reader is arranged to transmit an enable signal to the RFID tag to make the lock circuit enable the power supply to provide electrical power to the antenna for repeatedly transmitting the tag ID code; and
a central controller arranged to receive the tag ID code through the reader, wherein the reader is arranged to report its position to the central controller to identify a position of the RFID tag within the region.

7. The RFID monitoring system as claimed in claim 6, wherein the central controller is further arranged to set the assigned ID code and transmit the assigned ID code to the reader.

8. The RFID monitoring system as claimed in claim 6, wherein the reader is arranged to transmit a signal for the RFID tag to convert the signal into electrical power for transmitting the tag ID code.

9. The RFID monitoring system as claimed in claim 6, wherein the RFID tag further comprises:
a voltage converter arranged to convert a signal transmitted from the reader into electrical power for the control circuit to transmit the tag ID code through the antenna.

10. The RFID monitoring system as claimed in claim 6, wherein the lock circuit is arranged to disable the power supply from providing electrical power after the power supply is enabled for a predetermined period.

11. A radio frequency identification (RFID) tag, comprises:
an antenna arranged to receive an enable signal or a disable signal;
a control circuit electrically connected to the antenna;
a power supply arranged to provide electrical power to the control circuit for transmitting a tag ID code through the antenna; and
a lock circuit electrically connected to the power supply, wherein the lock circuit is arranged to enable and disable the power supply according to the enable signal and the disable signal, respectively.

12. The RFID tag as claimed in claim 11, comprising:
a voltage converter arranged to convert a signal received by the antenna into electrical power for the control circuit to transmit the tag ID code through the antenna.

13. The RFID tag as claimed in claim 11, wherein the lock circuit is arranged to disable the power supply from providing electrical power after the power supply is enabled for a predetermined period.

14. A radio frequency identification (RFID) monitoring method, comprising the steps of:
a. receiving a tag ID code of an RFID tag by at least one reader disposed in a region, wherein the RFID tag comprising a control circuit electrically connected to an antenna and a power supply, the control circuit is arranged to store the tag ID code, and the power supply is enabled or disabled by a lock circuit;
b. transmitting an enable signal by one of the readers to enable the power supply to provide electrical power when the RFID enters the region;
c. determining whether the tag ID code is the same as an assigned code provided by a central controller when the reader receives the tag ID code; and
d. when the tag ID code is the same as the assigned code, reporting the positions of the readers to the central controller, and identifying a route of the RFID tag moving within the region according to the positions of the readers.
